(19) United States
(12) Patent Application Publication
(10) Pub. No.: US 2022/0369089 A1
(43) Pub. Date: Nov. 17, 2022

(54) OPTIMIZED SIB1 SCHEDULING

(71) Applicant: QUALCOMM Incorporated, San Diego, CA (US)

(72) Inventors: Karthik VENKATRAM, San Diego, CA (US); Daniel AMERGA, San Diego, CA (US); Shanshan WANG, San Diego, CA (US)

(21) Appl. No.: 17/662,811

(22) Filed: May 10, 2022

Related U.S. Application Data
(60) Provisional application No. 63/189,054, filed on May 14, 2021.

(51) Int. Cl. H04W 4/90; H04W 24/08; H04W 72/12; H04L 1/16

(52) U.S. Cl. CPC H04W 4/90; H04W 24/08; H04W 72/1263; H04L 1/1642

(57) ABSTRACT

The present disclosure relates to methods and devices for wireless communication including an apparatus, e.g., a UE and/or a network node. In one aspect, the apparatus may monitor for at least one SIB1 from a network node. The apparatus may also receive, from the network node, at least one SIB1, the at least one SIB1 being associated with scheduling information for other system information including at least one of a SIB type, an SI periodicity, SI window information, or validity information. The apparatus may also read the at least one SIB1 after reception from the network node, the at least one SIB1 being read once for each modification period of a plurality of modification periods. The apparatus may also decode the at least one SIB1 based on reading the at least one SIB1 once for each modification period.

### CROSS REFERENCE TO RELATED APPLICATION(S)

This application claims the benefit of and priority to U.S. Provisional Application Ser. No. 63/189,054, entitled “OPTIMIZED SIB1 SCHEDULING” and filed on May 14, 2021, which is expressly incorporated by reference herein in its entirety.

### TECHNICAL FIELD

The present disclosure relates generally to communication systems, and more particularly, to system information block type 1 (SIB1) scheduling.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive, from a network node, a master information block (MIB) prior to receiving at least one system information block type 1 (SIB1) from the network node, where the at least one SIB1 is based on the MIB. The apparatus may also monitor for at least one SIB1 from a network node. Additionally, the apparatus may receive, from the network node, at least one SIB1, the at least one SIB1 being associated with scheduling information for other system information (SI) including at least one of a system information block (SIB) type, an SI periodicity, SI window information, or validity information. The apparatus may also read the at least one SIB1 after reception from the network node, the at least one SIB1 being read once for each modification period of a plurality of modification periods. The apparatus may also decode the at least one SIB1 based on reading the at least one SIB1 once for each modification period. Moreover, the apparatus may determine whether to monitoring for at least one public warning system (PWS) notification message from the network node. The apparatus may also monitor for the at least one PWS notification message based on the determination to monitor for the at least one PWS notification message; and start at least one per-segment timer associated with the at least one PWS notification message. The apparatus may also receive, from the network node, the at least one PWS notification message; and restart the at least one per-segment timer after the at least one PWS notification message is received from the network node. Further, the apparatus may adjust a public warning system (PWS) per-segment timeout period based on a time remaining in a modification period when at least one per-segment timer has timed out and a SIB1 timeout period. The apparatus may also start or not start, if at least one segment of a public warning system (PWS) notification message is received, a per-segment timer based on a geographical scope of the at least one PWS notification message. The apparatus may also stop reading the at least one SIB1 if a random access channel (RACH) procedure is successful.

In another aspect of the disclosure, a method, a computer-readable medium, and an apparatus are provided. The apparatus may be a network node or a base station. The apparatus may transmit, to at least one UE, a master information block (MIB) prior to transmitting at least one system information block type 1 (SIB1) to the at least one UE, where the at least one SIB1 is based on the MIB. The apparatus may also encode at least one SIB1, the at least one SIB1 being associated with scheduling information for other system information (SI) including at least one of a system information block (SIB) type, an SI periodicity, SI window information, or validity information. The apparatus may also transmit, to at least one UE, the at least one SIB1, the at least one SIB1 being transmitted via a broadcast message. The apparatus may also transmit, to the at least one UE, at least one public warning system (PWS) notification message, the at least one PWS notification message being transmitted as a broadcast message.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example system information acquisition procedure including a UE and a network node.

FIG. 5A is a diagram illustrating an example timeline for a SIB1 scheduling process.

FIG. 5B is a diagram illustrating an example timeline for a SIB1 scheduling process.

FIG. 6A is a diagram illustrating an example timeline for a SIB1 scheduling process.

FIG. 6B is a diagram illustrating an example timeline for a SIB1 scheduling process.

FIG. 7 is a diagram illustrating example communication between a UE and a network node.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus.

FIG. 13 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

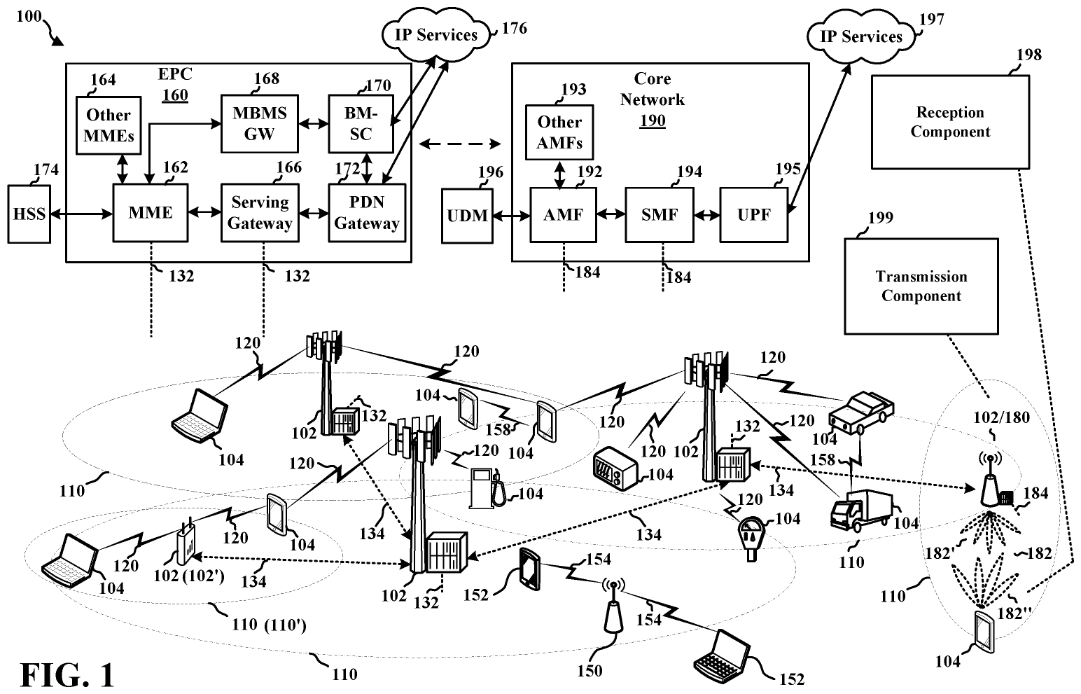

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The base station 180 (e.g., millimeter wave base station) may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network. A network node can be implemented as a base station (i.e., an aggregated base station), as a disaggregated base station, an integrated access and backhaul (IAB) node, a relay node, a sidelink node, etc. For example, a network node can be implemented as a central unit (CU), a distributed unit (DU), a radio unit (RU), a Near-Real Time (Near-RT) RAN Intelligent Controller (RIC), or a Non-Real Time (Non-RT) RIC in a disaggregated base station architecture or a disaggregated RAN architecture. In some aspects, a network node may be referred to as a network entity.

Referring again to FIG. 1, in certain aspects, the UE 104 may include a reception component 198 configured to receive, from a network node, a master information block (MIB) prior to receiving at least one system information block type 1 (SIB1) from the network node, where the at least one SIB1 is based on the MIB. Reception component 198 may also be configured to monitor for at least one SIB1 from a network node. Reception component 198 may also be configured to receive, from the network node, at least one SIB1, the at least one SIB1 being associated with scheduling information for other system information (SI) including at least one of a system information block (SIB) type, an SI periodicity, SI window information, or validity information. Reception component 198 may also be configured to read the at least one SIB1 after reception from the network node, the at least one SIB1 being read once for each modification period of a plurality of modification periods. Reception component 198 may also be configured to decode the at least one SIB1 based on reading the at least one SIB1 once for each modification period. Reception component 198 may also be configured to determine whether to monitoring for at least one public warning system (PWS) notification message from the network node. Reception component 198 may also be configured to monitor for the at least one PWS notification message based on the determination to monitor for the at least one PWS notification message; and start at least one per-segment timer associated with the at least one PWS notification message. Reception component 198 may also be configured to receive, from the network node, the at least one PWS notification message; and restart the at least one per-segment timer after the at least one PWS notification message is received from the network node. Reception component 198 may also be configured to adjust a public warning system (PWS) per-segment timeout period based on a time remaining in a modification period when at least one per-segment timer has timed out and a SIB1 timeout period. Reception component 198 may also be configured to start or not start, if at least one segment of a public warning system (PWS) notification message is received, a per-segment timer based on a geographical scope of the at least one PWS notification message. Reception component 198 may also be configured to stop reading the at least one SIB1 if a random access channel (RACH) procedure is successful.

Referring again to FIG. 1, in certain aspects, the base station 180 may include a transmission component 199 configured to transmit, to at least one UE, a master information block (MIB) prior to transmitting at least one system information block type 1 (SIB1) to the at least one UE, where the at least one SIB1 is based on the MIB. Transmission component 199 may also be configured to encode at least one SIB1, the at least one SIB1 being associated with scheduling information for other system information (SI) including at least one of a system information block (SIB) type, an SI periodicity, SI window information, or validity information. Transmission component 199 may also be configured to transmit, to at least one UE, the at least one SIB1, the at least one SIB1 being transmitted via a broadcast message. Transmission component 199 may also be configured to transmit, to the at least one UE, at least one public warning system (PWS) notification message, the at least one PWS notification message being transmitted as a broadcast message.

Although the following description may be focused on 5G NR, the concepts described herein may be applicable to other similar areas, such as LTE, LTE-A, CDMA, GSM, and other wireless technologies.

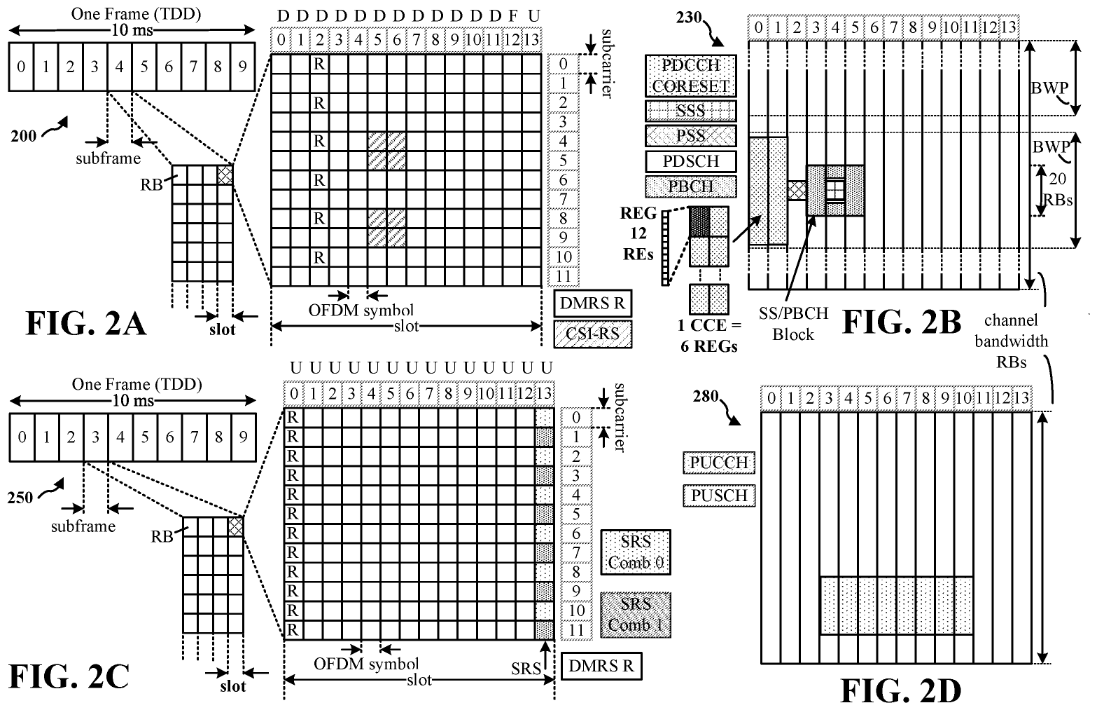

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on whether the cyclic prefix (CP) is normal or extended. For normal CP, each slot may include 14 symbols, and for extended CP, each slot may include 7 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

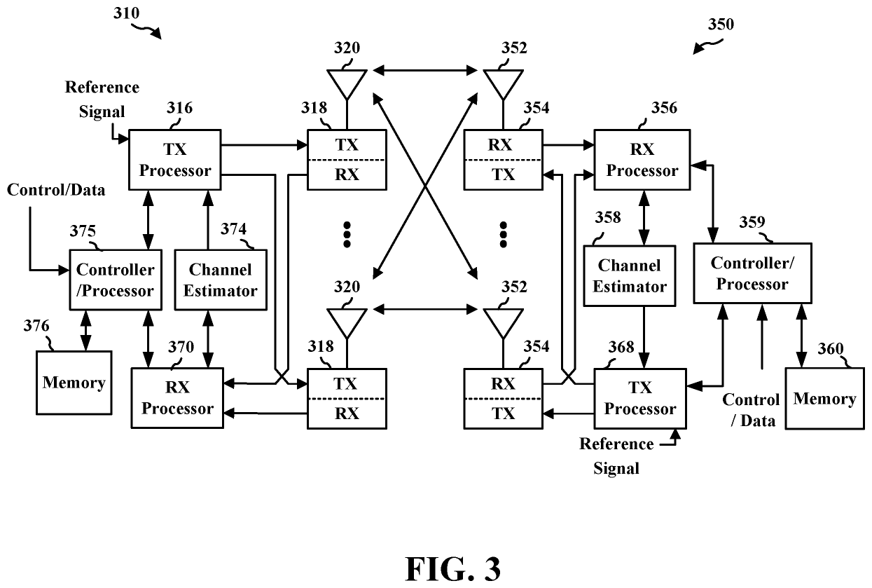

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via a separate transmitter (TX) 354. Each transmitter (TX) 354 may modulate an RF carrier with a respective spatial stream for transmission.

The UL transmission is processed at the base station 310 in a manner similar to that described in connection with the receiver function at the UE 350. Each receiver (RX) 318 receives a signal through its respective antenna 320. Each receiver (RX) 318 recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

Some aspects of wireless communication may transfer system information (SI) between UEs and a network node or base station. The system information may be transferred via different types of communication, e.g., broadcast, multicast, groupcast, and/or unicast communication. In some instances, broadcast, multicast, or groupcast communication may refer to a transmission by one device, e.g., a base station or UE, to other devices. Broadcast communication may refer to communication that is delivered to all types of devices, e.g., broadcast by a network node (e.g., a base station) to all UEs in an area. Multicast or groupcast communication may be delivered to multiple intended recipient devices, e.g., a small group of UEs in an area. Unicast communication may refer to a transmission from a one device, e.g., a base station or network node, to another other device, e.g., a UE.

The transfer of system information may include a number of information blocks, e.g., a master information block (MIB) and a system information block (SIB). The MIB may include different types of system information, as well as different parameters, e.g., parameters for decoding a SIB. The SIB associated with the MIB may correspond to different types of SIBs, e.g., a SIB type one or SIB1 (SIB1) that may include various types of system information. The MIB and the SIB1 may provide the minimum system information (SI) for an initial access procedure. In some aspects, the MIB may transmit system information including a subcarrier spacing, a system frame number (SFN), a configuration of a PDCCH control resource set (CORESET), a cell barred indicator, a cell reselection indicator, a raster offset, and/or a search space for SIB1. Additionally, the SIB1 may transmit remaining minimum system information (RMSI) including a random access search space, a paging search space, and/or downlink or uplink configuration information. Other system information (OSI) may also be transmitted from a base station or network node. In some instances, if the SI changes over time, the scheduling entity may send paging messages that indicate a change in the SI. Based on this, a UE may periodically monitor a paging channel for these paging messages and other types of paging messages. If a paging message indicates that the SI has changed, the UE may monitor a broadcast channel or some other designated channel for the updated SI.

The different types of SIBs may include different types of information. For instance, the SIB1 may provide scheduling information and/or availability of other SIB types or information, e.g., public land mobile network (PLMN) information and/or cell barring information, that may assist a UE in performing cell selection/reselection. For example, a UE may search for a suitable cell based on SIB1 information received from a network node or a base station. Other SIB types may include a SIB type two (SIB2), a SIB type three (SIB3), a SIB type four (SIB4), and a SIB type five (SIBS). A SIB2 may provide information for cell reselection that is common for inter-frequency cell reselection, intra-frequency cell reselection, and inter-radio access technology (inter-RAT) cell reselection. For example, a SIB2 may include measurement thresholds for a UE to determine when to start searching for another cell, cell priorities for cell reselection, and/or cell reselection criteria. A SIB3 may provide neighboring cell related information for intra-frequency cell reselection. For instance, a SIB3 may include physical cell identifier (ID) information associated with an intra-frequency neighboring cell or corresponding criteria for cell reselection. A SIB4 may provide neighboring cell related information for inter-frequency cell reselection. For example, a SIB4 may include physical cell ID information, frequency carrier information, frequency band information, and/or beam information associated with an inter-frequency neighboring cell or other criteria for cell reselection. A SIBS may provide neighboring cell related information for inter-RAT cell reselection. For instance, a SIBS may include RAT information, frequency carrier information, frequency band information, and/or beam information associated with an inter-RAT neighboring cell or other criteria for cell reselection.

In some instances, an inter-RAT cell reselection may include a UE camped on an NR cell and reselecting to camp on an LTE cell, or vice versa. Also, an inter-RAT cell reselection may be based on a selection of a UE. For certain types of cells, e.g., an intra-frequency neighbor cell of a serving cell, the SIB3 may include information to guide a UE to reselect to the neighbor cell. Moreover, if a neighbor cell is an inter-frequency neighbor cell of the serving cell, the SIB4 may include information to guide a UE to reselect to the neighbor cell. If the neighbor cell is an inter-RAT neighboring cell of the serving cell, the SIBS may include information to guide a UE to reselect to the neighbor cell. In some aspects, after obtaining the MIB, the RMSI, and the OSI, a UE may perform a random access (RA) procedure for initial access to a RAN, network node, or base station. Additionally, the RAN, network node, or base station may broadcast information that enables a UE to determine how to conduct the initial access. This information may include a configuration for a random access channel (RACH) that the UE uses to communicate with the RAN during initial access. The RACH configuration may indicate the resources allocated by the RAN for the RACH.

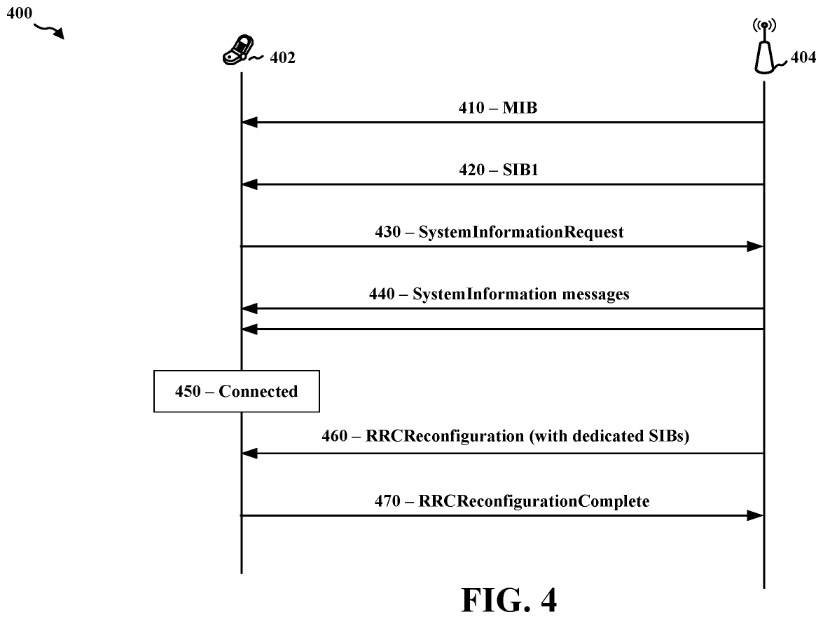

FIG. 4 illustrates a diagram 400 of a system information acquisition procedure including a UE 402 and a network node 404 (e.g., a base station). As shown in FIG. 4, at 410, network node 404 may transmit a MIB to UE 402. At 420, network node 404 may transmit a SIB1 to UE 402. At 430, UE 402 may transmit a system information request to network node 404. Based on this request, at 440, network node 404 may transmit one or more system information messages to UE 402. At 450, the network node 404 may transition the UE 402 to a connected state. After this connected state transition, at 460, network node 404 may transmit an RRC reconfiguration message (RRCReconfiguration) to UE 402, which may include a number of dedicated SIBs. In response, at 470, UE 402 may transmit an RRC reconfiguration complete message (RRCReconfigurationComplete) to network node 404.

As depicted in FIG. 4, a SIB1 may be broadcast periodically by a network node to one or more UEs. The SIB1 may be transmitted by the network node on a downlink shared channel (DL-SCH) with a certain periodicity, e.g., a periodicity of 160 ms, and a variable transmission repetition periodicity within a time period, e.g., 160 ms. The default transmission repetition periodicity of the SIB1 may be 20 ms, but the actual transmission repetition periodicity may be based on a network implementation. After receiving the SIB1, the UE may check the SIB1 which provides the scheduling information for other system information (OSI), e.g., SIB type, validity information, SI periodicity, and/or SI-window information. If an OSI search space (SS) is enabled, the UE can send an SI request to read the OSI, and the UE may monitor the SI window of the requested SIB in one or more SI periodicities of that SIB.

Additionally, if the network node/base station is broadcasting other types of SIBs, e.g., a SIB type six (SIB6), a SIB type seven (SIB7), and/or a SIB type eight (SIB8), a UE may acquire these types of SIBs in the same manner as a SIB1 (i.e., over a broadcast channel). In some instances, a SIB7 may be acquired by the UE until a complete message is built. During this process, the UE may also monitor the SIB1 in order to be notified of any change in status. Further, the SIB8 may be acquired by the UE until scheduling information is present in the SIB1. Thus, the SIB1 may be monitored by the UE, as a change in scheduling information (i.e., the removal of SIB8) may not be indicated by the network node/base station. Similarly, when SIBs are transmitted dynamically or on-demand, a change in broadcast status may not be indicated by the network node/base station. As such, in order to monitor a scheduling information status or a broadcast status, a UE may need to monitor the SIB1 constantly, as this update may be transmitted at any type of SIB periodicity (e.g., 160 ms) as opposed to transmitted at a modification boundary.

In some aspects, when scheduling a SIB7/SIB8 or on-demand SIBs, the UE may also monitor for a SIB1. This is because for a public warning system (PWS) notification message, removal of PWS scheduling information may not necessarily be indicated by the network to the UE. Thus, the UE may monitor for a SIB1 in order to be notified of a status update. Similarly, for on-demand SIBs, a change in the broadcast status or an update of a configuration with respect to on-demand SIBs (e.g., a RACH configuration) may not be indicated to a UE via a short message indication. In some instances, these SIB1 updates may not occur solely at a modification boundary. Thus, a UE may need to decode the SIB1 in order to obtain a status notification. However, reading a SIB1 too often may result in significant power usage at the UE, as the SIB1 decoding may occur too frequently. For example, a SIB1 may be decoded every 20 ms, which may persist for a long period of time. Also, reading a SIB1 too infrequently may cause a UE to miss status updates and result in the UE entering failure flows, e.g., based on timeouts.

Based on the above, it may be beneficial to adjust a SIB1 reading schedule, such that the SIB1 is not read too often and not read too infrequently. As mentioned herein, reading the SIB1 too frequently may cause an increased power consumption, but reading the SIB1 too infrequently may cause a UE to miss status updates. Moreover, for a PWS notification message, this may result in an unwanted radio link failure (RLF) in connected mode or a reselection in idle mode. Further, in on-demand mode, this may result in not updating a RACH procedure. As such, it may be beneficial to schedule a SIB1 reading in an optimized manner.

Aspects of the present disclosure may adjust (i.e., increase or decrease) a scheduling of a SIB1 reading process. That is, aspects of the present disclosure may read a SIB1 in an optimized manner, such that the SIB1 is read neither too often nor too infrequently. By doing so, aspects of the present disclosure may reduce the power consumption at a UE for a SIB1 reading process. Also, aspects of the present disclosure may cause a UE to receive all relevant status updates from a network node/base station. Moreover, aspects of the present disclosure may allow a UE to avoid an unwanted RLF, as well as allow a UE to maintain important updates to RACH procedures.

Aspects of the present disclosure may include a number of different examples of scheduling a SIB1 reading process, which may include SIB1 scheduling in scenarios with a PWS notification message. For example, aspects of the present disclosure may allow a UE to read a SIB1 once for a certain time period, e.g., 20 ms. In this example, a UE may accurately monitor switches in a configuration. Also, for certain time periods, this may result in a UE frequently reading/decoding a SIB.

In some aspects of the present disclosure, a UE may read a SIB1 once every modification period. Also, there may be no timer started for reading a segment of a PWS notification message. As such, there may not be any RLF or reselection and the UE may acquire segments of a PWS notification message on a current cell. Further, the UE may not reselect or RLF to a different cell, such as if a commercial mobile alert system (CMAS) message geographical scope (GS) is not a cell scope.

Additionally, in some aspects of the present disclosure, a UE may extend a per-segment timeout period of a PWS notification message. For example, the per-segment timeout period may be extended up to a SIB1 timeout. The UE may read a SIB1 once every modification period and the SIB1 may be scheduled from the start of every modification period. If at least one segment is received, based on the geographical scope (GS) of the message, e.g., obtained from a serial ID inside a SIB7 or SIB8, a per-segment timer (per_segment_timer) may be started. That is, if a geographical scope is cell wide or corresponds to a cell scope, the per-segment timer may not be started. However, if the geographical scope is based on a location area, a service area, a tracking area, or a public land mobile network (PLMN) area, the per-segment timer may be started.

Aspects of the present disclosure may also adjust the per-segment timeout period (per_seg_to) when starting the per-segment timer. For example, the adjusted per-segment timeout period (adjusted_per_seg_to) may be equal to the previous per-segment timeout period (per_seg_to) plus a remaining time in a modification period (remaining_time_in_mod_period) plus a SIB1 timeout period (Sib1_to). This may correspond to the following formula: adjusted_pws_seg_to##x=per_seg_to +remaining_time_in_mod_period+Sib1_to. Also, the remaining time in a modification period may be equal to a modification period minus a current frame (curr_frame) plus the previous per-segment timeout period (modulo operation) the modification period (mod_period). This may correspond to the following formula: remaining_time_in_mod_period=mod_period−(curr_frame+per_seg_to) mod mod_period. In the above formulas, x is the readjustment happening for every xth restart, one frame may be equal to 10 ms, per_seg_to is the timeout period started per-segment, adjusted_pws_seg_to is the per_seg_to expiration based on a SIB1 scheduling status time that is adjusted to a new value given by adjusted_pws_seg_to, remaining_sib1_to is the amount of time remaining for a SIB1 timeout period, Sib1_to is the amount of time given for SIB1 decoding (e.g., 64 frames), remaining_time_in_mod period is the remaining time in the modification period when the per_seg_to would have expired, mod_period is the modification period computed from the SIB1 (i.e., the actual modification period that is expressed in a number of radio frames m is equal to modificationPeriodCoeff*defaultPagingCycle).

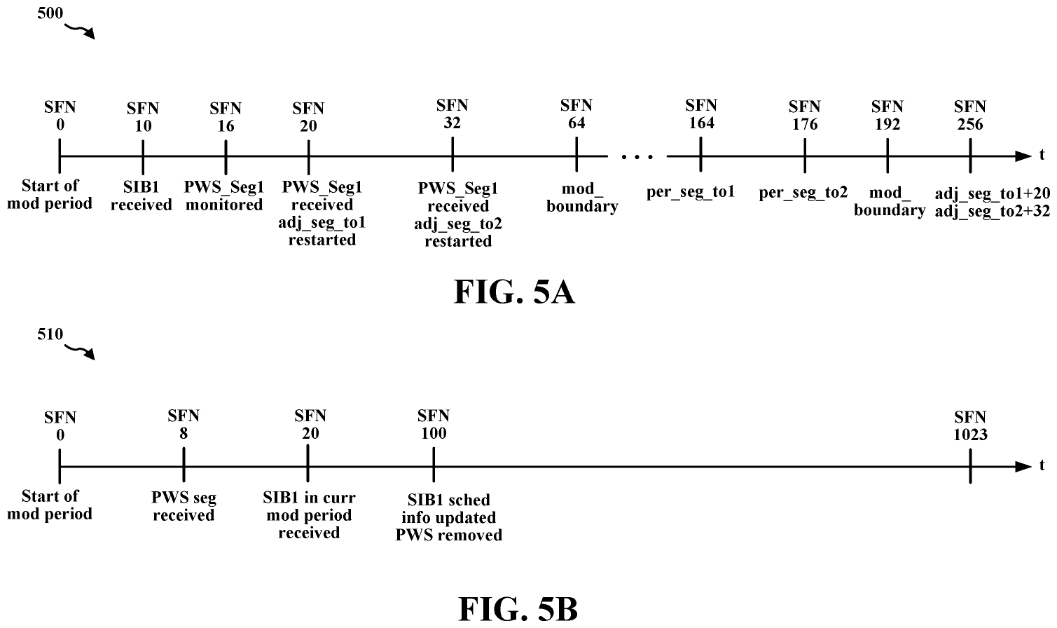

FIG. 5A and FIG. 5B illustrate diagram 500 and diagram 510, respectively, of timelines for a SIB1 scheduling process. As shown in FIG. 5A, at SFN 10, a SIB1 is received after a start of a modification period at SFN 0. At SFN 16, a first segment of a PWS notification message (PWS_Seg1) is monitored. At SFN 20, PWS_Seg1 is received and a first adjacent segment timeout (adj_seg_to1) is restarted. At SFN 32, PWS_Seg1 is received and a second adjacent segment timeout (adj_seg_to2) is restarted. SFN 64 corresponds to a modification boundary (mod_boundary). As indicated in FIG. 5A, there may be a modification boundary at SFN 128 (i.e., every 64 frames). SFN 164 corresponds to a first per-segment timeout period (per_seg_to1). SFN 176 corresponds to a second per-segment timeout period (per_seg_to2). Also, SFN 192 corresponds to a modification boundary (mod_boundary). SFN 256 corresponds to adj_seg_to1+20 frames and adj_seg_to2+32 frames. In the example shown in FIG. 5A, a SIB1 may be read before a per-segment timer actually times out. Also, a UE may be reading a PWS notification message for a long time after the network has removed it. For example, if a SIB8 periodicity is 8 frames (i.e., every 80 ms) and a modification boundary is 1024 frames (i.e., every 10.24 seconds), then a UE may be attempting to read a SIB8 for 10.16 seconds, which may be sub-optimal if the network has removed the PWS scheduling information at SFN 20 (i.e., 200 ms).

FIG. 5B is a diagram 510 of another timeline for a SIB1 scheduling process. As shown in FIG. 5B, at SFN 8, a segment of a PWS notification message is received after a start of a modification period at SFN 0. At SFN 20, a SIB1 may be received in a current modification period. Also, at SFN 100, SIB1 scheduling information may be updated to remove PWS scheduling information. As illustrated in FIG. 5B, diagram 510 includes up to SFN 1023.

Aspects of the present disclosure may also puncture a timeline in order to read a SIB1. For instance, a UE may read a SIB1 at least once every modification period. The first SIB1 that is read may be at the start of the modification period. If at least one segment is received, based on the geographical scope (GS) of the message (i.e., obtained from a serial ID inside SIB7 or SIB8), a per-segment timer may be started per-segment. That is, if a geographical scope is cell wide or corresponds to a cell scope, a per-segment timer may not be started. However, if the geographical scope is based on a location area, a service area, a tracking area, or a public land mobile network (PLMN) area, the per-segment timer may be started.

Aspects of the present disclosure may also schedule a SIB1 based on a number of different factors. For instance, a SIB1 may be scheduled at an SFN, such that SFN mod a=0, where 1≤a≤1024 and a is based on a frequency of reading the at least one SIB1. For example, if a=2, the SIB1 is read once every 20 ms. Also, if a=modification period, the SIB1 is read once every modification period. Aspects of the present disclosure may optimally select a value of a. In some instances, a SIB1 may be scheduled at an SFN that corresponds to per_seg_to−x, where x is number of frames prior to PWS segment timeout when a SIB1 read is enabled. Aspects of the present disclosure may utilize the above conditions to optimally handle the different combinations of SI periodicity and a modification boundary. In some aspects, an SI periodicity range may be equal to [rf8, rf16, rf32, rf64, rf128, rf256, rf512]. Also, a PWS segment timeout threshold (PWS_seg_time_out_thresh) may be based on a maximum of (N*SI periodicity, Nsery of a DRX cycle length (nserv_drx)). N may be a configurable number (e.g., N=4 or some other number). Nsery may be dependent on a DRX cycle length and different numerology (e.g., FR1 vs. FR2). For example, PWS_seg_time_out_thresh may be equal to MAX(4*si_periodicity_frames, nserv_drx). Also, a modification period range (mod_period_range)=[64, 128, 256, 512, 1024/0]. In some aspects, when the logic is met and SIB1 is already scheduled due to other reasons (e.g., a short message), then no action may be needed and the SIB1 read may be ongoing. In some instances, the most optimal result may occur with default values of a=64 and x=16. Additionally, the frequency may be chosen based on the modification boundary and the per-segment timeout period. For instance, if the modification boundary is greater than a threshold (x), then SFN mod a=0, where 64≤a≤x and x≤256. As a result, the SIB1 read may not become too infrequent. Here, 64 corresponds to the minimum modification period.

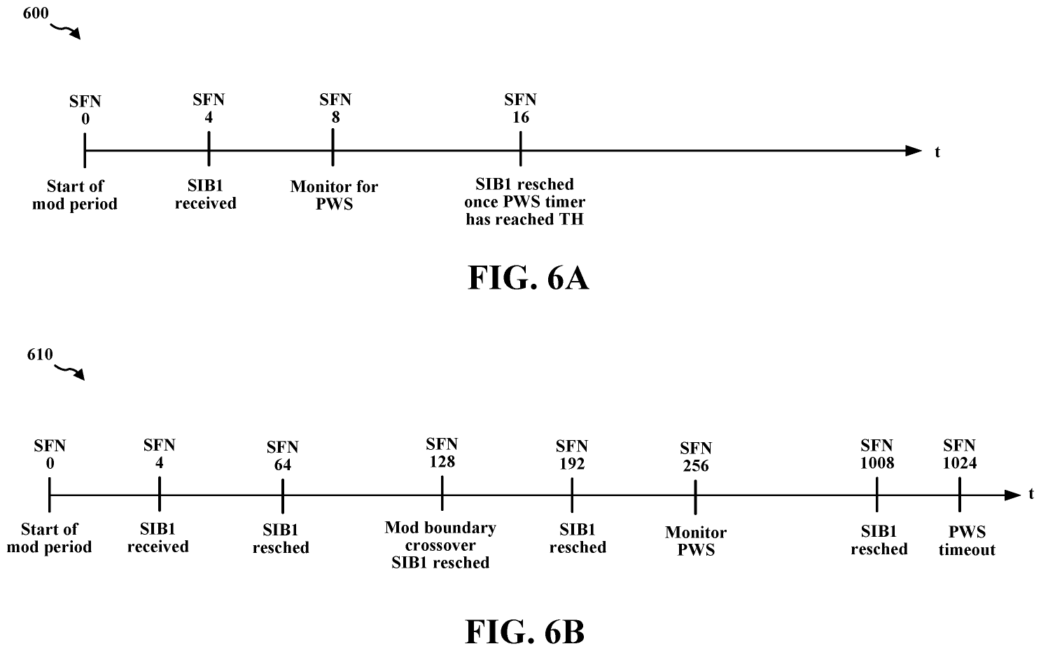

FIG. 6A and FIG. 6B illustrate diagram 600 and diagram 610, respectively, of timelines for a SIB1 scheduling process. As shown in FIG. 6A, at SFN 4, a SIB1 is received after a start of a modification period at SFN 0. At SFN 8, the UE may monitor for a PWS notification message. FIG. 6A also shows that, at SFN 16, a SIB1 is rescheduled once a PWS timer has reached a threshold. For instance, as shown in FIG. 6A, a PWS periodicity is 8, per_seg_to is 32, and the modification periodicity is 512. Accordingly, the SIB1 scheduling may be at every frame corresponding to (per_seg_to−x). If x=16, then every time per_seg_to reaches 32−16=16, the SIB1 is scheduled.

FIG. 6B is a diagram 610 of another timeline for a SIB1 scheduling process. As shown in FIG. 6B, at SFN 4, a SIB1 is received after a start of a modification period at SFN 0. The SIB1 is rescheduled at SFN 64, as well as at SFN 128 along with a modification boundary crossover. The SIB1 is also rescheduled at SFN 192. At SFN 256, the UE monitors for a PWS notification message. For instance, as shown in FIG. 6A, the PWS periodicity is 256, the PWS segment timeout threshold (pws_seg_timeout_thresh) is 1024, and the modification periodicity (mod_periodicity) is 128. As the SIB1 is scheduled by: SFN mod a (e.g., a=64), then the SIM is scheduled at the following SFNs: 0, 64, 128, 192, . . . , etc. Further, SIB1 scheduling=1024−x (e.g., x=16)=1008. FIG. 6B also shows that the PWS timeout occurs at SFN 1024.

Some aspects of the present disclosure may include SIB1 scheduling for dynamic or on-demand SIBscenarios. For instance, a SIB1 may be read every 20 ms during a RACH process, which may be performed to monitor if a network started broadcasting the SIBs. This may occur based on which UE may abort its ongoing RACH procedure or changed its RACH parameters. For such changes in scheduling information, there may not be a short message.

Additionally, a SIB1 may be read once in a 160 ms periodicity (i.e., SFN mod a=0, where a=16) instead of once every 20 ms. This means if a SIB1 was successfully received in a first 20 ms, the UE may not need to attempt to decode the SIB1 in next 140 ms. Further, a SIB1 read may be stopped once the RACH procedure is successful. On a crossing modification boundary, a SIB1 may be re-enabled and the latest broadcast status may be checked. If the RACH procedure was successful, the network may be expected to keep broadcasting a status at least until the end of the current modification period, after which it may be up to the network to continue or stop. If there is a transition from broadcast to not-broadcast status, in order to be aware of such a scenario, the UE may re-schedule the SIB1. In some instances, the UE may re-schedule the SIB1 if the modification period is different from the modification period where RACH for ODSI was successful. The UE may also re-schedule the SIB1 if no ODSI RACH is triggered. For example, the at least one SIB1 may be scheduled at a system frame number (SFN), such that SFN mod a=0, where 16≤a≤1024. Also, the at least one SIB1 may be scheduled based on a timeout threshold of other system information (OSI)−x, where x=16.

The aforementioned procedures may ensure a SIB1 is periodically read to determine a status, and if the status has moved to not broadcasting, the UE may trigger a RACH procedure as it may be aware the network has stopped scheduling. This may also cover the scenarios where when the UE initially reads a SIB1, the status may have been broadcasting and UE may have never known from this SIB1 that the OSIs may have been on-demand and have been broadcasting, e.g., due to a different UE triggering the on-demand procedure. In one instance, for a SIB1 read in a current modification period and an OSI status broadcasting, an OSI periodicity is 8 and a remaining time in the modification period is 40. In this instance, a network may stop broadcasting OSIs, and a UE may utilize timeout triggering failure call flows like panic reselection. By re-scheduling the SIB1 as mentioned above, the UE may utilize these timeout triggering failure call flows.

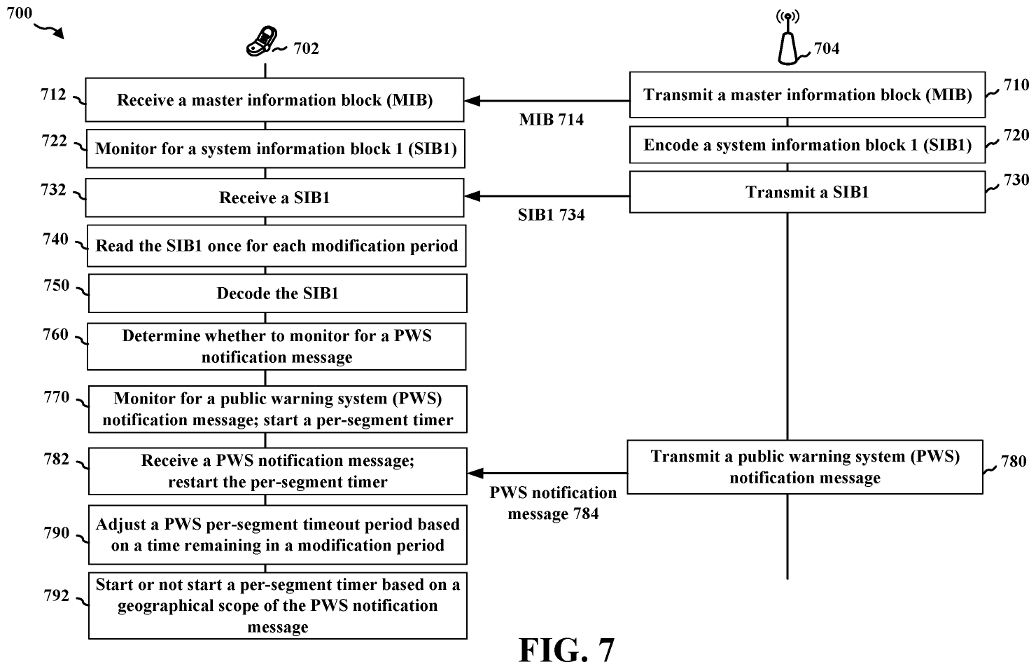

FIG. 7 is a diagram 700 illustrating example communication between a UE 702 and a network node 704 (e.g., a base station). At 710, network node 704 may transmit, to at least one UE, e.g., UE 702, a master information block (MIB), e.g., MIB 714, prior to transmitting at least one system information block type 1 (SIB1) to the at least one UE, where the at least one SIB1 is based on the MIB. At 712, UE 702 may receive, from a network node, e.g., network node 704, a master information block (MIB), e.g., MIB 714, prior to receiving at least one system information block type 1 (SIB1) from the network node, where the at least one SIB1 is based on the MIB.

At 720, network node 704 may encode at least one SIB1, the at least one SIB1 being associated with scheduling information for other system information (SI) including at least one of a system information block (SIB) type, an SI periodicity, SI window information, or validity information.

At 722, UE 702 may monitor for at least one SIB1 from a network node.

At 730, network node 704 may transmit, to at least one UE, e.g., UE 702, the at least one SIB1, e.g., SIB1 734, the at least one SIB1 being transmitted via a broadcast message.

At 732, UE 702 may receive, from the network node, e.g., network node 704, at least one SIB1, e.g., SIB1 734, the at least one SIB1 being associated with scheduling information for other system information (SI) including at least one of a system information block (SIB) type, an SI periodicity, SI window information, or validity information.

At 740, UE 702 may read the at least one SIB1 after reception from the network node, the at least one SIB1 being read once for each modification period of a plurality of modification periods. In some instances, UE 702 may stop reading the at least one SIB1 if a random access channel (RACH) procedure is successful.

In some aspects, reading the at least one SIB1 once for each modification period may include attempting to decode the at least one SIB1 once for each modification period. The at least one SIB1 may be read once every 20 milliseconds (ms), and the at least one SIB1 may be scheduled at a system frame number (SFN), such that SFN mod a=0, where a=2 or a=16. Also, the at least one SIB1 may be read once for each modification period and the at least one SIB1 is not associated with a public warning system (PWS) per-segment timer, and the at least one SIB1 may be scheduled at a SFN, such that SFN mod a=0, where a=a length of a modification period.

At 750, UE 702 may decode the at least one SIB1 based on reading the at least one SIB1 once for each modification period.

At 760, UE 702 may determine whether to monitoring for at least one public warning system (PWS) notification message from the network node.

At 770, UE 702 may monitor for the at least one PWS notification message based on the determination to monitor for the at least one PWS notification message; and start at least one per-segment timer associated with the at least one PWS notification message.

At 780, network node 704 may transmit, to the at least one UE, e.g., UE 702, at least one public warning system (PWS) notification message, e.g., PWS notification message 784, the at least one PWS notification message being transmitted as a broadcast message.

At 782, UE 702 may receive, from the network node, e.g., network node 704, the at least one PWS notification message, e.g., PWS notification message 784, and restart the at least one per-segment timer after the at least one PWS notification message is received from the network node.

At 790, UE 702 may adjust a public warning system (PWS) per-segment timeout period based on a time remaining in a modification period when at least one per-segment timer has timed out and a SIB1 timeout period.

At 792, UE 702 may start or not start, if at least one segment of a public warning system (PWS) notification message is received, a per-segment timer based on a geographical scope of the at least one PWS notification message. The per-segment timer may be not started if the geographical scope of a latest PWS notification message of the at least one PWS notification message corresponds to a cell scope, and the per-segment timer may be started if the geographical scope of the at least one PWS notification message corresponds to at least one of a location area, a service area, a tracking area, or a public land mobile network (PLMN) area.

Further, the at least one SIB1 may be scheduled at a system frame number (SFN), such that SFN mod a=0, where 1≤a≤1024, a being based on a frequency of reading the at least one SIB1. The frequency of reading the at least one SIB1 may be based on a modification boundary and a public warning system (PWS) per-segment timeout period, such that if the modification boundary is greater than a threshold (x), SFN mod a=0, where 64≤a≤x and x≤256. Also, the at least one SIB1 may be scheduled at a system frame number (SFN) based on a public warning system (PWS) per-segment timeout period and a number of frames prior to the PWS per-segment timeout period for SIB1 reading enabled.

Additionally, the at least one SIB1 may be read once every 20 milliseconds (ms) during a random access channel (RACH) procedure. The at least one SIB1 may be read once every 160 milliseconds (ms), and the at least one SIB1 may be scheduled at a system frame number (SFN), such that SFN mod a=0, where a=16. The at least one SIB1 may be scheduled at a system frame number (SFN), such that SFN mod a=0, where 16≤a≤1024. The at least one SIB1 may be scheduled based on a timeout threshold of other system information (OSI). The at least one SIB1 may be received during a random access channel (RACH) procedure.

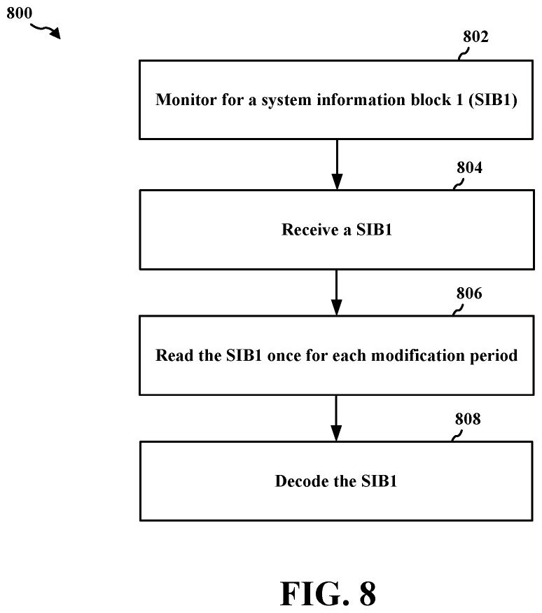

FIG. 8 is a flowchart 800 of a method of wireless communication. The method may be performed by a UE or a component of a UE (e.g., the UE 104, 350, 402, 702; apparatus 1202). The methods described herein can provide a number of benefits, such as improving communication signaling, resource utilization, and/or power savings.

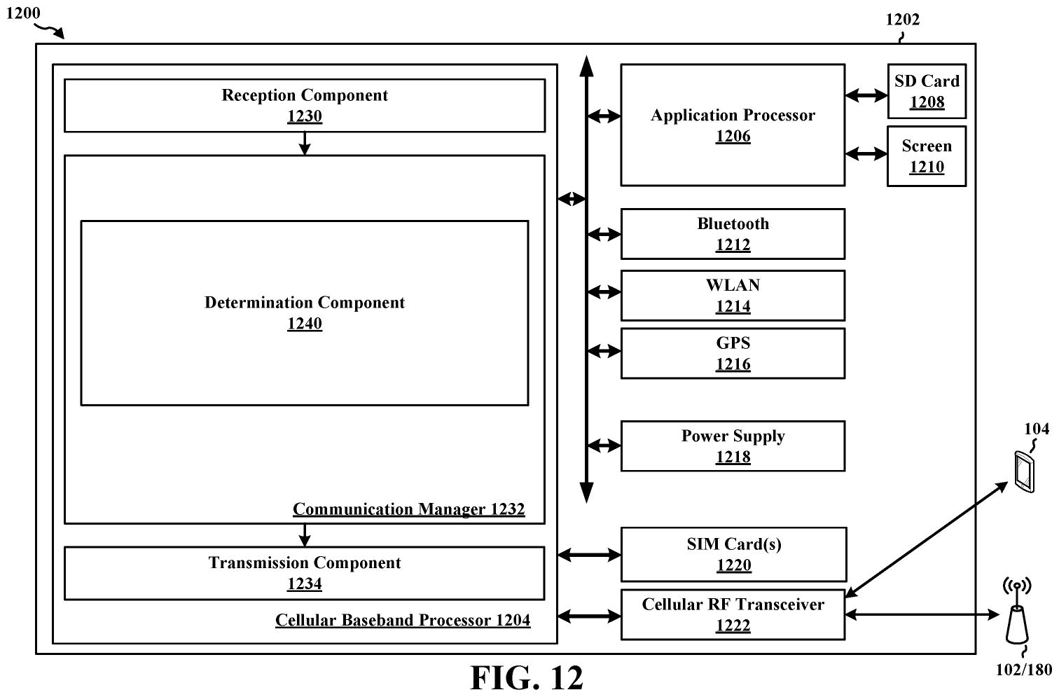

At 802, the apparatus may monitor for at least one SIB1 from a network node (e.g., a base station), as described in connection with the examples in FIGS. 4-7. For example, as shown in step 722 of FIG. 7, UE 702 may monitor for at least one SIB1 from a network node. Further, 802 may be performed by determination component 1240 in FIG. 12.

At 804, the apparatus may receive, from the network node, at least one SIB1, the at least one SIB1 being associated with scheduling information for other system information (SI) including at least one of a system information block (SIB) type, an SI periodicity, SI window information, or validity information, as described in connection with the examples in FIGS. 4-7. For example, as shown in step 732 of FIG. 7, UE 702 may receive, from the network node, at least one SIB1, the at least one SIB1 being associated with scheduling information for other system information (SI) including at least one of a system information block (SIB) type, an SI periodicity, SI window information, or validity information. Further, 804 may be performed by determination component 1240 in FIG. 12.

At 806, the apparatus may read the at least one SIB1 after reception from the network node, the at least one SIB1 being read once for each modification period of a plurality of modification periods, as described in connection with the examples in FIGS. 4-7. For example, as shown in step 740 of FIG. 7, UE 702 may read the at least one SIB1 after reception from the network node, the at least one SIB1 being read once for each modification period of a plurality of modification periods. Further, 806 may be performed by determination component 1240 in FIG. 12. In some instances, the apparatus may stop reading the at least one SIB1 if a random access channel (RACH) procedure is successful.

In some aspects, reading the at least one SIB1 once for each modification period may include attempting to decode the at least one SIB1 once for each modification period. The at least one SIB1 may be read once every 20 milliseconds (ms), and the at least one SIB1 may be scheduled at a system frame number (SFN), such that SFN mod a=0, where a=2 or a=16. Also, the at least one SIB1 may be read once for each modification period and the at least one SIB1 is not associated with a public warning system (PWS) per-segment timer, and the at least one SIB1 may be scheduled at a SFN, such that SFN mod a=0, where a=a length of a modification period.

At 808, the apparatus may decode the at least one SIB1 based on reading the at least one SIB1 once for each modification period, as described in connection with the examples in FIGS. 4-7. For example, as shown in step 750 of FIG. 7, UE 702 may decode the at least one SIB1 based on reading the at least one SIB1 once for each modification period. Further, 808 may be performed by determination component 1240 in FIG. 12.

Also, the at least one SIB1 may be scheduled at a system frame number (SFN), such that SFN mod a=0, where 1≤a≤1024, a being based on a frequency of reading the at least one SIB1. The frequency of reading the at least one SIB1 may be based on a modification boundary and a public warning system (PWS) per-segment timeout period, such that if the modification boundary is greater than a threshold (x), SFN mod a=0, where 64≤a≤x and x≤256. Also, the at least one SIB1 may be scheduled at a system frame number (SFN) based on a public warning system (PWS) per-segment timeout period and a number of frames prior to the PWS per-segment timeout period for SIB1 reading enabled.

Moreover, the at least one SIB1 may be read once every 20 milliseconds (ms) during a random access channel (RACH) procedure. The at least one SIB1 may be read once every 160 milliseconds (ms), and the at least one SIB1 may be scheduled at a system frame number (SFN), such that SFN mod a=0, where a=16. The at least one SIB1 may be scheduled at a system frame number (SFN), such that SFN mod a=0, where 16≤a≤1024. The at least one SIB1 may be scheduled based on a timeout threshold of other system information (OSI). The at least one SIB1 may be received during a random access channel (RACH) procedure.

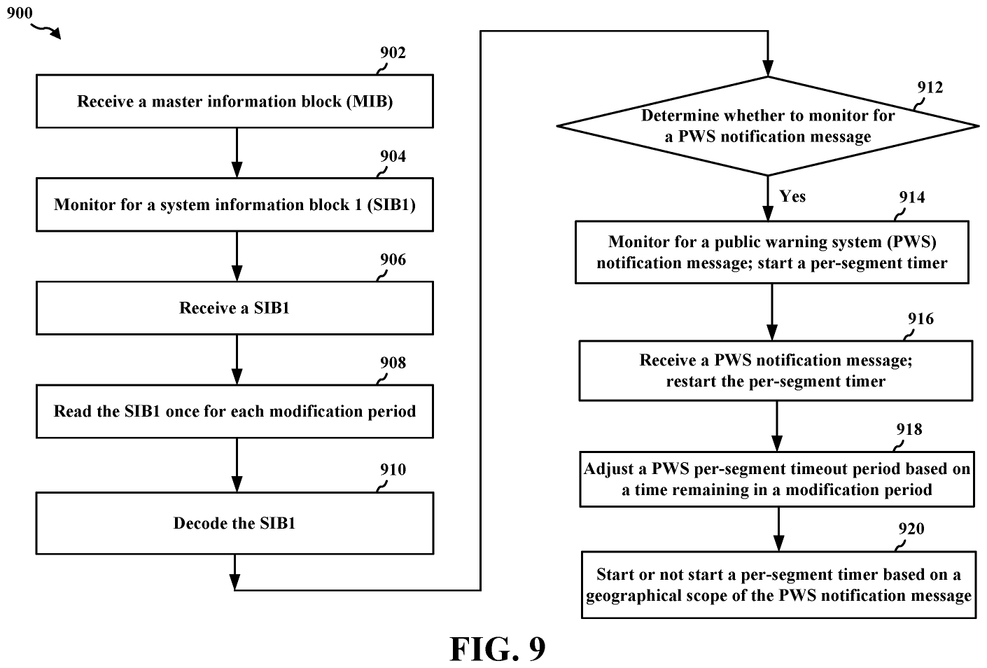

FIG. 9 is a flowchart 900 of a method of wireless communication. The method may be performed by a UE or a component of a UE (e.g., the UE 104, 350, 402, 702; apparatus 1202). The methods described herein can provide a number of benefits, such as improving communication signaling, resource utilization, and/or power savings.

At 902, the apparatus may receive, from a network node (e.g., a base station), a master information block (MIB) prior to receiving at least one system information block type 1 (SIB1) from the network node, where the at least one SIB1 is based on the MIB, as described in connection with the examples in FIGS. 4-7. For example, as shown in step 712 of FIG. 7, UE 702 may receive, from a network node, a master information block (MIB) prior to receiving at least one system information block type 1 (SIB1) from the network node, where the at least one SIB1 is based on the MIB. Further, 902 may be performed by determination component 1240 in FIG. 12.

At 904, the apparatus may monitor for at least one SIB1 from a network node, as described in connection with the examples in FIGS. 4-7. For example, as shown in step 722 of FIG. 7, UE 702 may monitor for at least one SIB1 from a network node. Further, 904 may be performed by determination component 1240 in FIG. 12.

At 906, the apparatus may receive, from the network node, at least one SIB1, the at least one SIB1 being associated with scheduling information for other system information (SI) including at least one of a system information block (SIB) type, an SI periodicity, SI window information, or validity information, as described in connection with the examples in FIGS. 4-7. For example, as shown in step 732 of FIG. 7, UE 702 may receive, from the network node, at least one SIB1, the at least one SIB1 being associated with scheduling information for other system information (SI) including at least one of a system information block (SIB) type, an SI periodicity, SI window information, or validity information. Further, 906 may be performed by determination component 1240 in FIG. 12.

At 908, the apparatus may read the at least one SIB1 after reception from the network node, the at least one SIB1 being read once for each modification period of a plurality of modification periods, as described in connection with the examples in FIGS. 4-7. For example, as shown in step 740 of FIG. 7, UE 702 may read the at least one SIB1 after reception from the network node, the at least one SIB1 being read once for each modification period of a plurality of modification periods. Further, 908 may be performed by determination component 1240 in FIG. 12. In some instances, the apparatus may stop reading the at least one SIB1 if a random access channel (RACH) procedure is successful.

In some aspects, reading the at least one SIB1 once for each modification period may include attempting to decode the at least one SIB1 once for each modification period. The at least one SIB1 may be read once every 20 milliseconds (ms), and the at least one SIB1 may be scheduled at a system frame number (SFN), such that SFN mod a=0, where a=2 or a=16. Also, the at least one SIB1 may be read once for each modification period and the at least one SIB1 is not associated with a public warning system (PWS) per-segment timer, and the at least one SIB1 may be scheduled at a SFN, such that SFN mod a=0, where a=a length of a modification period.

At 910, the apparatus may decode the at least one SIB1 based on reading the at least one SIB1 once for each modification period, as described in connection with the examples in FIGS. 4-7. For example, as shown in step 750 of FIG. 7, UE 702 may decode the at least one SIB1 based on reading the at least one SIB1 once for each modification period. Further, 910 may be performed by determination component 1240 in FIG. 12.

At 912, the apparatus may determine whether to monitoring for at least one public warning system (PWS) notification message from the network node, as described in connection with the examples in FIGS. 4-7. For example, as shown in step 760 of FIG. 7, UE 702 may determine whether to monitoring for at least one public warning system (PWS) notification message from the network node. Further, 912 may be performed by determination component 1240 in FIG. 12.

At 914, the apparatus may monitor for the at least one PWS notification message based on the determination to monitor for the at least one PWS notification message; and start at least one per-segment timer associated with the at least one PWS notification message, as described in connection with the examples in FIGS. 4-7. For example, as shown in step 770 of FIG. 7, UE 702 may monitor for the at least one PWS notification message based on the determination to monitor for the at least one PWS notification message; and start at least one per-segment timer associated with the at least one PWS notification message. Further, 914 may be performed by determination component 1240 in FIG. 12.

At 916, the apparatus may receive, from the network node, the at least one PWS notification message; and restart the at least one per-segment timer after the at least one PWS notification message is received from the network node, as described in connection with the examples in FIGS. 4-7. For example, as shown in step 782 of FIG. 7, UE 702 may receive, from the network node, the at least one PWS notification message; and restart the at least one per-segment timer after the at least one PWS notification message is received from the network node. Further, 916 may be performed by determination component 1240 in FIG. 12.

At 918, the apparatus may adjust a public warning system (PWS) per-segment timeout period based on a time remaining in a modification period when at least one per-segment timer has timed out and a SIB1 timeout period, as described in connection with the examples in FIGS. 4-7. For example, as shown in step 790 of FIG. 7, UE 702 may adjust a public warning system (PWS) per-segment timeout period based on a time remaining in a modification period when at least one per-segment timer has timed out and a SIB1 timeout period. Further, 918 may be performed by determination component 1240 in FIG. 12.

At 920, the apparatus may start or not start, if at least one segment of a public warning system (PWS) notification message is received, a per-segment timer based on a geographical scope of the at least one PWS notification message, as described in connection with the examples in FIGS. 4-7. For example, as shown in step 792 of FIG. 7, UE 702 may start or not start, if at least one segment of a public warning system (PWS) notification message is received, a per-segment timer based on a geographical scope of the at least one PWS notification message. Further, 920 may be performed by determination component 1240 in FIG. 12. The per-segment timer may be not started if the geographical scope of a latest PWS notification message of the at least one PWS notification message corresponds to a cell scope, and the per-segment timer may be started if the geographical scope of the at least one PWS notification message corresponds to at least one of a location area, a service area, a tracking area, or a public land mobile network (PLMN) area.

The at least one SIB1 may also be scheduled at a system frame number (SFN), such that SFN mod a=0, where 1≤a≤1024, a being based on a frequency of reading the at least one SIB1. The frequency of reading the at least one SIB1 may be based on a modification boundary and a public warning system (PWS) per-segment timeout period, such that if the modification boundary is greater than a threshold (x), SFN mod a=0, where 64≤a≤x and x≤256. Also, the at least one SIB1 may be scheduled at a system frame number (SFN) based on a public warning system (PWS) per-segment timeout period and a number of frames prior to the PWS per-segment timeout period for SIB1 reading enabled.

Further, the at least one SIB1 may be read once every 20 milliseconds (ms) during a random access channel (RACH) procedure. The at least one SIB1 may be read once every 160 milliseconds (ms), and the at least one SIB1 may be scheduled at a system frame number (SFN), such that SFN mod a=0, where a=16. The at least one SIB1 may be scheduled at a system frame number (SFN), such that SFN mod a=0, where 16≤a≤1024. The at least one SIB1 may be scheduled based on a timeout threshold of other system information (OSI). The at least one SIB1 may be received during a random access channel (RACH) procedure.

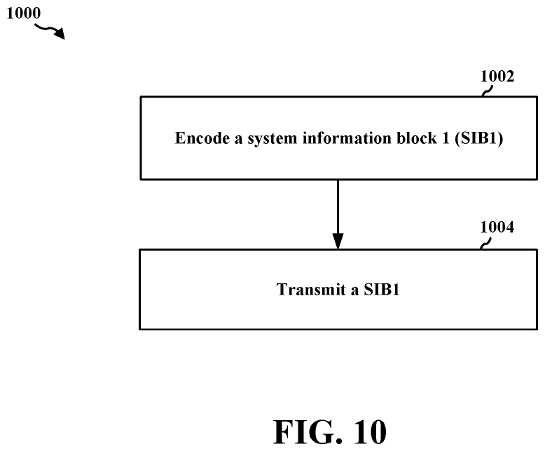

FIG. 10 is a flowchart 1000 of a method of wireless communication. The method may be performed by a network node or a base station, or a component of a network node or a base station (e.g., the base station 102, 180, 310, network node 404, network node 704; apparatus 1302). The methods described herein can provide a number of benefits, such as improving communication signaling, resource utilization, and/or power savings.

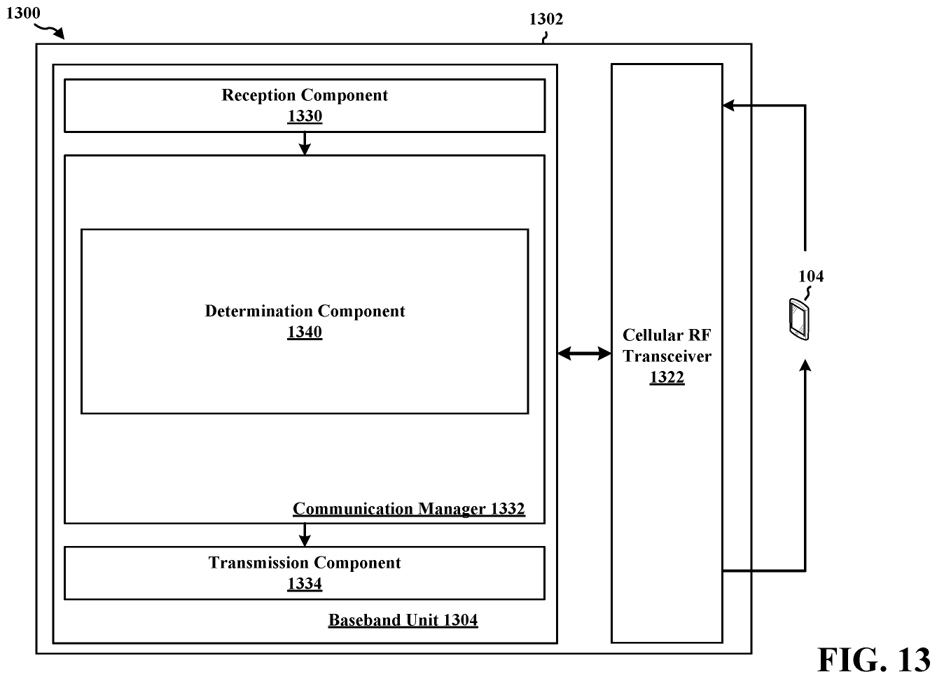

At 1002, the apparatus may encode at least one SIB1, the at least one SIB1 being associated with scheduling information for other system information (SI) including at least one of a system information block (SIB) type, an SI periodicity, SI window information, or validity information, as described in connection with the examples in FIGS. 4-7. For example, as shown in step 720 of FIG. 7, network node 704 may encode at least one SIB1, the at least one SIB1 being associated with scheduling information for other system information (SI) including at least one of a system information block (SIB) type, an SI periodicity, SI window information, or validity information. Further, 1002 may be performed by determination component 1340 in FIG. 13.

At 1004, the apparatus may transmit, to at least one UE, the at least one SIB1, the at least one SIB1 being transmitted via a broadcast message, as described in connection with the examples in FIGS. 4-7. For example, as shown in step 730 of FIG. 7, network node 704 may transmit, to at least one UE, the at least one SIB1, the at least one SIB1 being transmitted via a broadcast message. Further, 1004 may be performed by determination component 1340 in FIG. 13.

In some aspects, the at least one SIB1 may be scheduled at a system frame number (SFN), such that SFN mod a=0, where 1≤a≤1024, a being based on a frequency of reading the at least one SIB1. The frequency of reading the at least one SIB1 may be based on a modification boundary and a public warning system (PWS) per-segment timeout period, such that if the modification boundary is greater than a threshold (x), SFN mod a=0, where 64≤a≤x and x≤256. The at least one SIB1 may be scheduled at a system frame number (SFN) based on a public warning system (PWS) per-segment timeout period and a number of frames prior to the PWS per-segment timeout period for SIB1 reading enabled. The at least one SIB1 may be scheduled at a system frame number (SFN), such that SFN mod a=0, where 16≤a≤1024. The at least one SIB1 may be scheduled based on a timeout threshold of other system information (OSI). The at least one SIB1 may be transmitted during a random access channel (RACH) procedure.

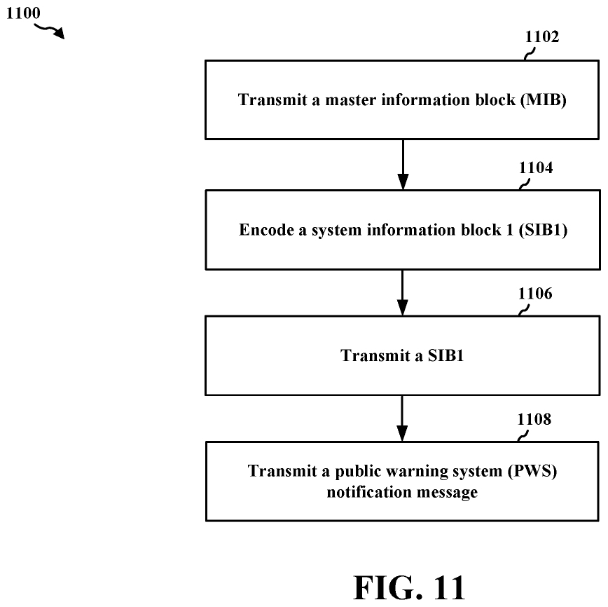

FIG. 11 is a flowchart 1100 of a method of wireless communication. The method may be performed by a network node or a base station, or a component of a network node or a base station (e.g., the base station 102, 180, 310, network node 404, network node 704; apparatus 1302). The methods described herein can provide a number of benefits, such as improving communication signaling, resource utilization, and/or power savings.

At 1102, the apparatus may transmit, to at least one UE, a master information block (MIB) prior to transmitting at least one system information block type 1 (SIB1) to the at least one UE, where the at least one SIB1 is based on the MIB, as described in connection with the examples in FIGS. 4-7. For example, as shown in step 710 of FIG. 7, network node 704 may transmit, to at least one UE, a master information block (MIB) prior to transmitting at least one system information block type 1 (SIB1) to the at least one UE, where the at least one SIB1 is based on the MIB. Further, 1102 may be performed by determination component 1340 in FIG. 13.

At 1104, the apparatus may encode at least one SIB1, the at least one SIB1 being associated with scheduling information for other system information (SI) including at least one of a system information block (SIB) type, an SI periodicity, SI window information, or validity information, as described in connection with the examples in FIGS. 4-7. For example, as shown in step 720 of FIG. 7, network node 704 may encode at least one SIB1, the at least one SIB1 being associated with scheduling information for other system information (SI) including at least one of a system information block (SIB) type, an SI periodicity, SI window information, or validity information. Further, 1104 may be performed by determination component 1340 in FIG. 13.

At 1106, the apparatus may transmit, to at least one UE, the at least one SIB1, the at least one SIB1 being transmitted via a broadcast message, as described in connection with the examples in FIGS. 4-7. For example, as shown in step 730 of FIG. 7, network node 704 may transmit, to at least one UE, the at least one SIB1, the at least one SIB1 being transmitted via a broadcast message. Further, 1106 may be performed by determination component 1340 in FIG. 13.

At 1108, the apparatus may transmit, to the at least one UE, at least one public warning system (PWS) notification message, the at least one PWS notification message being transmitted as a broadcast message, as described in connection with the examples in FIGS. 4-7. For example, as shown in step 780 of FIG. 7, network node 704 may transmit, to the at least one UE, at least one public warning system (PWS) notification message, the at least one PWS notification message being transmitted as a broadcast message. Further, 1108 may be performed by determination component 1340 in FIG. 13.

In some aspects, the at least one SIB1 may be scheduled at a system frame number (SFN), such that SFN mod a=0, where 1≤a≤1024, a being based on a frequency of reading the at least one SIB1. The frequency of reading the at least one SIB1 may be based on a modification boundary and a public warning system (PWS) per-segment timeout period, such that if the modification boundary is greater than a threshold (x), SFN mod a=0, where 64≤a≤x and x≤256. The at least one SIB1 may be scheduled at a system frame number (SFN) based on a public warning system (PWS) per-segment timeout period and a number of frames prior to the PWS per-segment timeout period for SIB1 reading enabled. The at least one SIB1 may be scheduled at a system frame number (SFN), such that SFN mod a=0, where 16≤a≤1024. The at least one SIB1 may be scheduled based on a timeout threshold of other system information (OSI). The at least one SIB1 may be transmitted during a random access channel (RACH) procedure.

FIG. 12 is a diagram 1200 illustrating an example of a hardware implementation for an apparatus 1202. The apparatus 1202 may be a UE, a component of a UE, or may implement UE functionality. In some aspects, the apparatus 1202 may include a cellular baseband processor 1204 (also referred to as a modem) coupled to a cellular RF transceiver 1222. In some aspects, the apparatus 1202 may further include one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, or a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., see 350 of FIG. 3) and include the aforediscussed additional modules of the apparatus 1202.

The communication manager 1232 includes a determination component 1240 that is configured to receive, from the network node, a master information block (MIB) prior to receiving the at least one SIB1 from the network node, where the at least one SIB1 is based on the MIB, e.g., as described in connection with step 902 in FIG. 9. Determination component 1240 may be further configured to monitor for at least one system information block 1 (SIB1) from a network node, e.g., as described in connection with step 904 in FIG. 9. Determination component 1240 may be further configured to receive, from the network node, at least one SIB1, the at least one SIB1 being associated with scheduling information for other system information (SI) including at least one of a system information block (SIB) type, an SI periodicity, SI window information, or validity information, e.g., as described in connection with step 906 in FIG. 9. Determination component 1240 may be further configured to read the at least one SIB1 after reception from the network node, the at least one SIB1 being read once for each modification period of a plurality of modification periods, e.g., as described in connection with step 908 in FIG. 9. Determination component 1240 may be further configured to decode the at least one SIB1 based on reading the at least one SIB1 once for each modification period, e.g., as described in connection with step 910 in FIG. 9. Determination component 1240 may be further configured to determine whether to monitoring for at least one public warning system (PWS) notification message from the network node, e.g., as described in connection with step 912 in FIG. 9. Determination component 1240 may be further configured to monitor for the at least one PWS notification message based on the determination to monitor for the at least one PWS notification message; and start at least one per-segment timer associated with the at least one PWS notification message, e.g., as described in connection with step 914 in FIG. 9. Determination component 1240 may be further configured to receive, from the network node, the at least one PWS notification message; and restart the at least one per-segment timer after the at least one PWS notification message is received from the network node, e.g., as described in connection with step 916 in FIG. 9. Determination component 1240 may be further configured to adjust a public warning system (PWS) per-segment timeout period based on a time remaining in a modification period when at least one per-segment timer has timed out and a SIB1 timeout period, e.g., as described in connection with step 918 in FIG. 9. Determination component 1240 may be further configured to start or not start, if at least one segment of a public warning system (PWS) notification message is received, a per-segment timer based on a geographical scope of the at least one PWS notification message, e.g., as described in connection with step 920 in FIG. 9.

The apparatus may include additional components that perform each of the blocks of the algorithm in the aforementioned flowcharts of FIGS. 7, 8, and 9. As such, each block in the aforementioned flowcharts of FIGS. 7, 8, and 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the cellular baseband processor 1204, may include means for receiving, from the network node, a master information block (MIB) prior to receiving the at least one SIB1 from the network node, where the at least one SIB1 is based on the MIB. The apparatus 1202 may also include means for monitoring for at least one system information block 1 (SIB1) from a network node. The apparatus 1202 may also include means for receiving, from the network node, at least one SIB1, the at least one SIB1 being associated with scheduling information for other system information (SI) including at least one of a system information block (SIB) type, an SI periodicity, SI window information, or validity information. The apparatus 1202 may also include means for reading the at least one SIB1 after reception from the network node, the at least one SIB1 being read once for each modification period of a plurality of modification periods. The apparatus 1202 may also include means for decoding the at least one SIB1 based on reading the at least one SIB1 once for each modification period. The apparatus 1202 may also include means for determining whether to monitoring for at least one public warning system (PWS) notification message from the network node. The apparatus 1202 may also include means for monitoring for the at least one PWS notification message based on the determination to monitor for the at least one PWS notification message. The apparatus 1202 may also include means for starting at least one per-segment timer associated with the at least one PWS notification message. The apparatus 1202 may also include means for receiving, from the network node, the at least one PWS notification message. The apparatus 1202 may also include means for restarting the at least one per-segment timer after the at least one PWS notification message is received from the network node. The apparatus 1202 may also include means for adjusting a public warning system (PWS) per-segment timeout period based on a time remaining in a modification period when at least one per-segment timer has timed out and a SIB1 timeout period. The apparatus 1202 may also include means for starting or not starting, if at least one segment of a public warning system (PWS) notification message is received, a per-segment timer based on a geographical scope of the at least one PWS notification message. The apparatus 1202 may also include means for stopping reading the at least one SIB1 if a random access channel (RACH) procedure is successful. The aforementioned means may be one or more of the aforementioned components of the apparatus 1202 configured to perform the functions recited by the aforementioned means. As described supra, the apparatus 1202 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 13 is a diagram 1300 illustrating an example of a hardware implementation for an apparatus 1302. The apparatus 1302 may be a network node, a base station, a component of a network node or a base station, or may implement network node or base station functionality. In some aspects, the apparatus 1302 may include a baseband unit 1304. The baseband unit 1304 may communicate through a cellular RF transceiver 1322 with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the base station 310 and may include the memory 376 and/or at least one of the TX processor 316, the RX processor 370, and the controller/processor 375.

The communication manager 1332 includes a determination component 1340 that is configured to transmit, to the at least one UE, a master information block (MIB) prior to transmitting the at least one SIB1 to the at least one UE, where the at least one SIB1 is based on the MIB, e.g., as described in connection with step 1102 in FIG. 11. Determination component 1340 may be further configured to encode at least one system information block 1 (SIB1), the at least one SIB1 being associated with scheduling information for other system information (SI) including at least one of a system information block (SIB) type, an SI periodicity, SI window information, or validity information, e.g., as described in connection with step 1104 in FIG. 11. Determination component 1340 may be further configured to transmit, to at least one user equipment (UE), the at least one SIB1, the at least one SIB1 being transmitted via a broadcast message, e.g., as described in connection with step 1106 in FIG. 11. Determination component 1340 may be further configured to transmit, to the at least one UE, at least one public warning system (PWS) notification message, the at least one PWS notification message being transmitted as a broadcast message, e.g., as described in connection with step 1108 in FIG. 11.

The apparatus may include additional components that perform each of the blocks of the algorithm in the aforementioned flowcharts of FIGS. 7, 10, and 11. As such, each block in the aforementioned flowcharts of FIGS. 7, 10, and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the baseband unit 1304, may include means for transmitting, to the at least one UE, a master information block (MIB) prior to transmitting the at least one SIB1 to the at least one UE, where the at least one SIB1 is based on the MIB. The apparatus 1302 may also include means for encoding at least one system information block 1 (SIB1), the at least one SIB1 being associated with scheduling information for other system information (SI) including at least one of a system information block (SIB) type, an SI periodicity, SI window information, or validity information. The apparatus 1302 may also include means for transmitting, to at least one user equipment (UE), the at least one SIB1, the at least one SIB1 being transmitted via a broadcast message. The apparatus 1302 may also include means for transmitting, to the at least one UE, at least one public warning system (PWS) notification message, the at least one PWS notification message being transmitted as a broadcast message. The aforementioned means may be one or more of the aforementioned components of the apparatus 1302 configured to perform the functions recited by the aforementioned means. As described supra, the apparatus 1302 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to: monitor for at least one system information block 1 (SIB1) from a network node (e.g., a base station); receive, from the network node, at least one SIB1, the at least one SIB1 being associated with scheduling information for other system information (SI) including at least one of a system information block (SIB) type, an SI periodicity, SI window information, or validity information; read the at least one SIB1 after reception from the network node, the at least one SIB1 being read once for each modification period of a plurality of modification periods; and decode the at least one SIB1 based on reading the at least one SIB1 once for each modification period.

Aspect 2 is the apparatus of aspect 1, where reading the at least one SIB1 once for each modification period includes attempting to decode the at least one SIB1 once for each modification period.

Aspect 3 is the apparatus of any of aspects 1 and 2, where the at least one processor is further configured to: determine whether to monitoring for at least one public warning system (PWS) notification message from the network node.

Aspect 4 is the apparatus of any of aspects 1 to 3, where the at least one processor is further configured to: monitor for the at least one PWS notification message based on the determination to monitor for the at least one PWS notification message; and start at least one per-segment timer associated with the at least one PWS notification message.

Aspect 5 is the apparatus of any of aspects 1 to 4, where the at least one processor is further configured to: receive, from the network node, the at least one PWS notification message; and restart the at least one per-segment timer after the at least one PWS notification message is received from the network node.

Aspect 6 is the apparatus of any of aspects 1 to 5, where the at least one SIB1 is read once every 20 milliseconds (ms), and the at least one SIB1 is scheduled at a system frame number (SFN), such that SFN mod a=0, where a=2 or a=16.

Aspect 7 is the apparatus of any of aspects 1 to 6, where the at least one SIB1 is read once for each modification period and the at least one SIB1 is not associated with a public warning system (PWS) per-segment timer, and the at least one SIB1 is scheduled at a system frame number (SFN), such that SFN mod a=0, where a=a length of a modification period.

Aspect 8 is the apparatus of any of aspects 1 to 7, where the at least one processor is further configured to: adjust a public warning system (PWS) per-segment timeout period based on a time remaining in a modification period when at least one per-segment timer has timed out and a SIB1 timeout period.

Aspect 9 is the apparatus of any of aspects 1 to 8, where the at least one processor is further configured to: start or not start, if at least one segment of a public warning system (PWS) notification message is received, a per-segment timer based on a geographical scope of the at least one PWS notification message.

Aspect 10 is the apparatus of any of aspects 1 to 9, where the per-segment timer is not started if the geographical scope of a latest PWS notification message of the at least one PWS notification message corresponds to a cell scope, and the per-segment timer is started if the geographical scope of the at least one PWS notification message corresponds to at least one of a location area, a service area, a tracking area, or a public land mobile network (PLMN) area.

Aspect 11 is the apparatus of any of aspects 1 to 10, where the at least one SIB1 is scheduled at a system frame number (SFN), such that SFN mod a=0, where 1≤a≤1024, a being based on a frequency of reading the at least one SIB1.

Aspect 12 is the apparatus of any of aspects 1 to 11, where the frequency of reading the at least one SIB1 is based on a modification boundary and a public warning system (PWS) per-segment timeout period, such that if the modification boundary is greater than a threshold (x), SFN mod a=0, where 64≤a≤x and x≤256.

Aspect 13 is the apparatus of any of aspects 1 to 12, where the at least one SIB1 is scheduled at a system frame number (SFN) based on a public warning system (PWS) per-segment timeout period and a number of frames prior to the PWS per-segment timeout period for SIB1 reading enabled.

Aspect 14 is the apparatus of any of aspects 1 to 13, where the at least one SIB1 is read once every 20 milliseconds (ms) during a random access channel (RACH) procedure.

Aspect 15 is the apparatus of any of aspects 1 to 14, where the at least one SIB1 is read once every 160 milliseconds (ms), and the at least one SIB1 is scheduled at a system frame number (SFN), such that SFN mod a=0, where a=16.

Aspect 16 is the apparatus of any of aspects 1 to 15, where the at least one processor is further configured to: stop reading the at least one SIB1 if a random access channel (RACH) procedure is successful.

Aspect 17 is the apparatus of any of aspects 1 to 16, where the at least one SIB1 is scheduled at a system frame number (SFN), such that SFN mod a=0, where 16≤a≤1024.

Aspect 18 is the apparatus of any of aspects 1 to 17, where the at least one SIB1 is scheduled based on a timeout threshold of first other system information (OSI).

Aspect 19 is the apparatus of any of aspects 1 to 18, where the at least one processor is further configured to: receive, from the network node, a master information block (MIB) prior to receiving the at least one SIB1 from the network node, where the at least one SIB1 is based on the MIB.

Aspect 20 is the apparatus of any of aspects 1 to 19, where the at least one SIB1 is received during a random access channel (RACH) procedure.

Aspect 21 is the apparatus of any of aspects 1 to 20, further including a transceiver coupled to the at least one processor.

Aspect 22 is a method of wireless communication for implementing any of aspects 1 to 21.

Aspect 23 is an apparatus for wireless communication including means for implementing any of aspects 1 to 21.

Aspect 24 is a non-transitory computer-readable medium storing computer executable code, where the code when executed by a processor causes the processor to implement any of aspects 1 to 21.

Aspect 25 is an apparatus for wireless communication at a network node (e.g., a base station) including at least one processor coupled to a memory and configured to: encode at least one system information block 1 (SIB1), the at least one SIB1 being associated with scheduling information for other system information (SI) including at least one of a system information block (SIB) type, an SI periodicity, SI window information, or validity information; and transmit, to at least one user equipment (UE), the at least one SIB1, the at least one SIB1 being transmitted via a broadcast message.

Aspect 26 is the apparatus of aspect 25, where the at least one processor is further configured to: transmit, to the at least one UE, at least one public warning system (PWS) notification message, the at least one PWS notification message being transmitted as a first broadcast message.

Aspect 27 is the apparatus of any of aspects 25 and 26, where the at least one SIB1 is scheduled at a system frame number (SFN), such that SFN mod a=0, where 1≤a≤1024, a being based on a frequency of reading the at least one SIB.

Aspect 28 is the apparatus of any of aspects 25 to 27, where the frequency of reading the at least one SIB1 is based on a modification boundary and a public warning system (PWS) per-segment timeout period, such that if the modification boundary is greater than a threshold (x), SFN mod a=0, where 64≤a≤x and x≤256.

Aspect 29 is the apparatus of any of aspects 25 to 28, where the at least one SIB1 is scheduled at a system frame number (SFN) based on a public warning system (PWS) per-segment timeout period and a number of frames prior to the PWS per-segment timeout period for SIB1 reading enabled.

Aspect 30 is the apparatus of any of aspects 25 to 29, where the at least one SIB1 is scheduled at a system frame number (SFN), such that SFN mod a=0, where 16≤a≤1024.

Aspect 31 is the apparatus of any of aspects 25 to 30, where the at least one SIB1 is scheduled based on a timeout threshold of first other system information (OSI).

Aspect 32 is the apparatus of any of aspects 25 to 31, where the at least one processor is further configured to: transmit, to the at least one UE, a master information block (MIB) prior to transmitting the at least one SIB1 to the at least one UE, where the at least one SIB1 is based on the MIB.

Aspect 33 is the apparatus of any of aspects 25 to 32, where the at least one SIB1 is transmitted during a random access channel (RACH) procedure.

Aspect 34 is the apparatus of any of aspects 25 to 33, further including a transceiver coupled to the at least one processor.

Aspect 35 is a method of wireless communication for implementing any of aspects 25 to 34.

Aspect 36 is an apparatus for wireless communication including means for implementing any of aspects 25 to 34.

Aspect 37 is a non-transitory computer-readable medium storing computer executable code, where the code when executed by a processor causes the processor to implement any of aspects 25 to 34.

What is claimed is:

1. An apparatus for wireless communication at a user equipment (UE), comprising:
a memory; and
at least one processor coupled to the memory and configured to:
monitor for at least one system information block 1 (SIB1) from a network node;
receive, from the network node, at least one SIB1, the at least one SIB1 being associated with scheduling information for other system information (SI) including at least one of a system information block (SIB) type, an SI periodicity, SI window information, or validity information;
read the at least one SIB1 after reception from the network node, the at least one SIB1 being read once for each modification period of a plurality of modification periods; and
decode the at least one SIB1 based on reading the at least one SIB1 once for each modification period.

2. The apparatus of claim 1, wherein reading the at least one SIB1 once for each modification period comprises attempting to decode the at least one SIB1 once for each modification period.

3. The apparatus of claim 1, wherein the at least one processor is further configured to:
determine whether to monitoring for at least one public warning system (PWS) notification message from the network node.

4. The apparatus of claim 3, wherein the at least one processor is further configured to:
monitor for the at least one PWS notification message based on the determination to monitor for the at least one PWS notification message; and
start at least one per-segment timer associated with the at least one PWS notification message.

5. The apparatus of claim 4, wherein the at least one processor is further configured to:
receive, from the network node, the at least one PWS notification message; and
restart the at least one per-segment timer after the at least one PWS notification message is received from the network node.

6. The apparatus of claim 1, wherein the at least one SIB1 is read once every 20 milliseconds (ms), and the at least one SIB1 is scheduled at a system frame number (SFN), such that SFN mod a=0, where a=2 or a=16.

7. The apparatus of claim 1, wherein the at least one SIB1 is read once for each modification period and the at least one SIB1 is not associated with a public warning system (PWS) per-segment timer, and the at least one SIB1 is scheduled at a system frame number (SFN), such that SFN mod a=0, where a=a length of a modification period.

8. The apparatus of claim 1, wherein the at least one processor is further configured to:
adjust a public warning system (PWS) per-segment timeout period based on a time remaining in a modification period when at least one per-segment timer has timed out and a SIB1 timeout period.

9. The apparatus of claim 1, wherein the at least one processor is further configured to:
start or not start, if at least one segment of a public warning system (PWS) notification message is received, a per-segment timer based on a geographical scope of the at least one PWS notification message.

10. The apparatus of claim 9, wherein the per-segment timer is not started if the geographical scope of a latest PWS notification message of the at least one PWS notification message corresponds to a cell scope, and the per-segment timer is started if the geographical scope of the at least one PWS notification message corresponds to at least one of a location area, a service area, a tracking area, or a public land mobile network (PLMN) area.

11. The apparatus of claim 1, wherein the at least one SIB1 is scheduled at a system frame number (SFN), such that SFN mod a=0, where 1≤a≤1024, a being based on a frequency of reading the at least one SIB1.

12. The apparatus of claim 11, wherein the frequency of reading the at least one SIB1 is based on a modification boundary and a public warning system (PWS) per-segment timeout period, such that if the modification boundary is greater than a threshold (x), SFN mod a=0, where 64≤a≤x and x≤256.

13. The apparatus of claim 1, wherein the at least one SIB1 is scheduled at a system frame number (SFN) based on a public warning system (PWS) per-segment timeout period and a number of frames prior to the PWS per-segment timeout period for SIB1 reading enabled.

14. The apparatus of claim 1, wherein the at least one SIB1 is read once every 20 milliseconds (ms) during a random access channel (RACH) procedure.

15. The apparatus of claim 1, wherein the at least one SIB1 is read once every 160 milliseconds (ms), and the at least one SIB1 is scheduled at a system frame number (SFN), such that SFN mod a=0, where a=16.

16. The apparatus of claim 1, wherein the at least one processor is further configured to:
stop reading the at least one SIB1 if a random access channel (RACH) procedure is successful.

17. The apparatus of claim 1, wherein the at least one SIB1 is scheduled at a system frame number (SFN), such that SFN mod a=0, where 16≤a≤1024.

18. The apparatus of claim 1, wherein the at least one SIB1 is scheduled based on a timeout threshold of first other system information (OSI).

19. The apparatus of claim 1, further comprising a transceiver coupled to the at least one processor, wherein the at least one processor is further configured to:
receive, from the network node, a master information block (MIB) prior to receiving the at least one SIB1 from the network node, wherein the at least one SIB1 is based on the MIB.

20. The apparatus of claim 1, wherein the at least one SIB1 is received during a random access channel (RACH) procedure.

21. An apparatus for wireless communication at a network node, comprising:
a memory; and
at least one processor coupled to the memory and configured to:
encode at least one system information block 1 (SIB1), the at least one SIB1 being associated with scheduling information for other system information (SI) including at least one of a system information block (SIB) type, an SI periodicity, SI window information, or validity information; and
transmit, to at least one user equipment (UE), the at least one SIB1, the at least one SIB1 being transmitted via a broadcast message.

22. The apparatus of claim 21, wherein the at least one processor is further configured to:
transmit, to the at least one UE, at least one public warning system (PWS) notification message, the at least one PWS notification message being transmitted as a first broadcast message.

23. The apparatus of claim 21, wherein the at least one SIB1 is scheduled at a system frame number (SFN), such that SFN mod a=0, where 1≤a≤1024, a being based on a frequency of reading the at least one SIB1.

24. The apparatus of claim 23, wherein the frequency of reading the at least one SIB1 is based on a modification boundary and a public warning system (PWS) per-segment timeout period, such that if the modification boundary is greater than a threshold (x), SFN mod a=0, where 64≤a≤x and x≤256.

25. The apparatus of claim 21, wherein the at least one SIB1 is scheduled at a system frame number (SFN) based on a public warning system (PWS) per-segment timeout period and a number of frames prior to the PWS per-segment timeout period for SIB1 reading enabled.

26. The apparatus of claim 21, wherein the at least one SIB1 is scheduled at a system frame number (SFN), such that SFN mod a=0, where 16≤a≤1024.

27. The apparatus of claim 21, wherein the at least one SIB1 is scheduled based on a timeout threshold of first other system information (OSI).

28. The apparatus of claim 21, further comprising a transceiver coupled to the at least one processor, wherein the at least one processor is further configured to:
transmit, to the at least one UE, a master information block (MIB) prior to transmitting the at least one SIB1 to the at least one UE, wherein the at least one SIB1 is based on the MIB.

29. A method of wireless communication at a user equipment (UE), comprising:
monitoring for at least one system information block 1 (SIB1) from a network node;
receiving, from the network node, at least one SIB1, the at least one SIB1 being associated with scheduling information for other system information (SI) including at least one of a system information block (SIB) type, an SI periodicity, SI window information, or validity information;
reading the at least one SIB1 after reception from the network node, the at least one SIB1 being read once for each modification period of a plurality of modification periods; and
decoding the at least one SIB1 based on reading the at least one SIB1 once for each modification period.

30. A method of wireless communication at a network node, comprising:
encoding at least one system information block 1 (SIB1), the at least one SIB1 being associated with scheduling information for other system information (SI) including at least one of a system information block (SIB) type, an SI periodicity, SI window information, or validity information; and
transmitting, to at least one user equipment (UE), the at least one SIB1, the at least one SIB1 being transmitted via a broadcast message.
